(19) United States
(12) Patent Application Publication
(10) Pub. No.: US 2021/0026290 A1
(43) Pub. Date: Jan. 28, 2021

(54) IMAGE FORMING APPARATUS

(71) Applicant: Konica Minolta, Inc., Tokyo (JP)

(72) Inventor: Yujiro Ishida, Tokyo (JP)

(21) Appl. No.: 16/921,914

(22) Filed: Jul. 6, 2020

(30) Foreign Application Priority Data
Jul. 25, 2019 (JP) 2019-137106

(51) Int. Cl. G03G 21/16

(52) U.S. Cl. CPC G03G 21/1647; G03G 21/1676

(57) ABSTRACT

An image forming apparatus includes a photoconductor and a developing device. The developing device supplies a developer to the photoconductor and is attachable to and detachable from a main body of the image forming apparatus. The main body includes a vibration mechanism that vibrates the developing device.

### CROSS-REFERENCE TO RELATED APPLICATIONS

The entire disclosure of Japanese Patent Application No. 2019-137106 filed on Jul. 25, 2019 is incorporated herein by reference in its entirety.

### BACKGROUND

### Technological Field

The present disclosure relates to an image forming apparatus.

### Description of the Related Art

There has been known a technology of, in an electrophotographic image forming apparatus, applying vibrations to a developing device, thereby dropping toner accumulated on the inner surface of a housing of the developing device, to curb generation of defective images on sheets of paper. For example, a developing device having a vibration mechanism is disclosed in JP 2018-22122 A.

### SUMMARY

Developing devices are usually treated as maintenance parts and replaced at predetermined timings due to their durability. In the case of JP 2018-22122 A, the vibration mechanism is replaced together with the developing device although the vibration mechanism has no problem in its durability. This produces wastes unnecessarily and increases running cost.

Objects of the present disclosure include curbing unnecessary production of wastes and increase in running cost.

In order to achieve at least one of the abovementioned objects, according to an aspect of the present invention, there is provided an image forming apparatus including:

a photoconductor; and

a developing device that supplies a developer to the photoconductor,

wherein the developing device is attachable to and detachable from a main body of the image forming apparatus, and

wherein the main body includes a vibration mechanism that vibrates the developing device.

### BRIEF DESCRIPTION OF THE DRAWINGS

The advantages and features provided by one or more embodiments of the present invention will become more fully understood from the detailed description given hereinbelow and the appended drawings that are given by way of illustration only, and thus are not intended as a definition of the limits of the present invention, wherein:

FIG. 1 schematically shows configuration of an image forming apparatus;

FIG. 2 is a perspective view showing a developing device;

FIG. 3 is a schematic view showing configuration of a rotator;

FIG. 4 shows the developing device at a development position;

FIG. 5 shows the developing device at a separate position;

FIG. 6 shows the developing device before pulled out;

FIG. 7 shows the developing device after pulled out;

FIG. 8 shows a vibration mechanism; and

FIG. 9 shows the vibration mechanism.

### DETAILED DESCRIPTION OF EMBODIMENTS

Hereinafter, one or more embodiments of the present invention will be described with reference to the drawings. However, the scope of the present invention is not limited to the disclosed embodiments or illustrated examples.

### [Image Forming Apparatus]

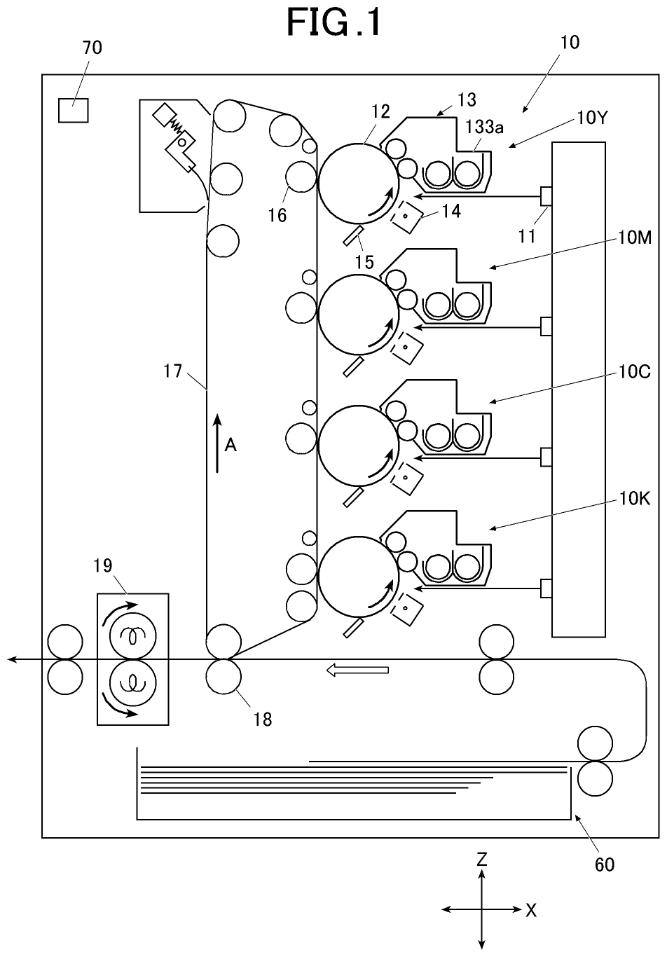

FIG. 1 is a schematic view showing configuration of an image forming apparatus 1 according to an embodiment(s).

In the following description, the width direction (right-left direction) of the image forming apparatus 1 is the X direction, the depth direction (front-back direction) of the image forming apparatus 1 is the Y direction, and the height direction (up-down direction) of the image forming apparatus 1 is the Z direction.

As shown in FIG. 1, the image forming apparatus 1 is an electrophotographic color image forming apparatus using an intermediate transfer system, and includes an image forming unit 10, a paper feeder 60 and a controller 70 (hardware processor).

The image forming unit 10 forms images composed of four colors of Y, M, C, K (YMCK images) on sheets of paper on the basis of pixel values of the four colors of each pixel of processed original images.

The image forming unit 10 includes four writing units 10Y, 10M, 10C, 10K, an intermediate transfer belt 17, a pair of second transfer rollers 18 and a fusing unit 19.

The four writing units 10Y, 10M, 10C, 10K are arranged in series (tandem) along the belt surface of the intermediate transfer belt 17, and form Y, M, C, K images, respectively.

The writing units 10Y, 10M, 10C, 10K are the same in configuration. The difference therebetween is only the color of images to form. Each of the writing units 10Y, 10M, 10C, 10K includes, as shown in FIG. 1, an optical scanner 11, a photoconductor 12, a developing device 13, a charger 14, a cleaner 15 and a first transfer roller 16.

At the time of image forming, in each of the writing units 10Y, 10M, 10C, 10K, the charger 14 charges the photoconductor 12, the optical scanner 11 emits a beam on the basis of an original image to scan the charged photoconductor 12, thereby forming an electrostatic latent image, and the developing device 13 supplies a color material, such as a toner, to develop the electrostatic latent image, thereby forming a toner image on the photoconductor 12.

The images formed on the photoconductors 12 of the four writing units 10Y, 10M, 10C, 10K are successively transferred onto the intermediate transfer belt 17 by their respective first transfer rollers 16 so as to be laid on top of one another (first transfer), so that an image composed of multiple colors (YMCK image) is formed on the intermediate transfer belt 17. The intermediate transfer belt 17 is wound around a plurality of rollers and rotates. After the first transfer, the cleaners 15 remove the color materials remaining on the respective photoconductors 12.

In the image forming unit 10, a sheet of paper is fed from the paper feeder 60 to the position of the second transfer rollers 18 so as to coincide with the YMCK image formed on the rotating intermediate transfer belt 17 reaching the position of the second transfer rollers 18. One of the second transfer rollers 18, which form a pair, contacts the intermediate transfer belt 17 by pressure. The other is one of the rollers around which the intermediate transfer belt 17 is wound. After the YMCK image on the intermediate transfer belt 17 is transferred onto the sheet by the pressure contact of the second transfer roller(s) 18 (second transfer), the sheet is conveyed to the fusing unit 19 to be subjected to fusing, and then ejected to a paper receiving tray.

The paper feeder 60 is disposed, for example, at the lower portion of the image forming apparatus 1, and has an attachable and detachable paper feeding tray. Sheets of paper stored in the paper feeding tray are sent out one by one from the top to a conveyance path by paper feeding rollers.

The controller 70 includes a central processing unit (CPU), a random access memory (RAM) and a read only memory (ROM), and controls operation of each component of the image forming apparatus 1.

### [Developing Device]

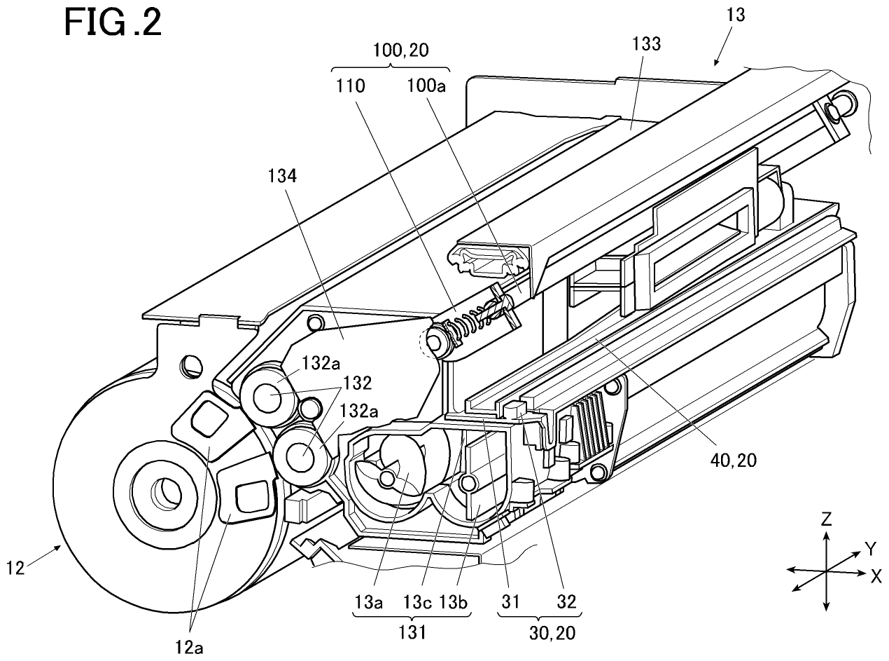

FIG. 2 is a perspective view showing the developing device 13.

As shown in FIG. 2, the developing device 13 is set so as to extend along the axial direction (Y direction) of the photoconductor 12.

The developing device 13 includes: a developer stirring unit 131 including a main stirrer 13a, an auxiliary stirrer 13b and a partition 13c; two developing rollers 132, 132; and a housing 133 housing these components, and has therein a developer containing, for example, a toner and a carrier.

In the developing device 13, the developer is partly conveyed to the developing rollers 132, 132 while being stirred with the main stirrer 13a and the auxiliary stirrer 13b. On the surfaces of the developing rollers 132, 132, layers of the developer are formed, and from these layers, the toner is supplied to a latent image on the photoconductor 12.

The housing 133 has a shape capable of housing the abovementioned components. More specifically, in a cross sectional view, its lower portion where the developer stirring unit 131 is disposed projects rightward as compared with its upper portion. Consequently, a recess 133a (shown in FIG. 1) is formed at the upper right portion of the housing 133.

On both end faces of the housing 133 in the Y direction, plates 134 that each contact bearings 132a of the developing rollers 132, 132 are disposed.

The plates 134 are disposed at positions where they can contact rotators 110 (pressing parts), which will be described later.

The developing device 13 is attachable to and detachable from the image forming apparatus 1 and is replaced as a maintenance part at a predetermined timing.

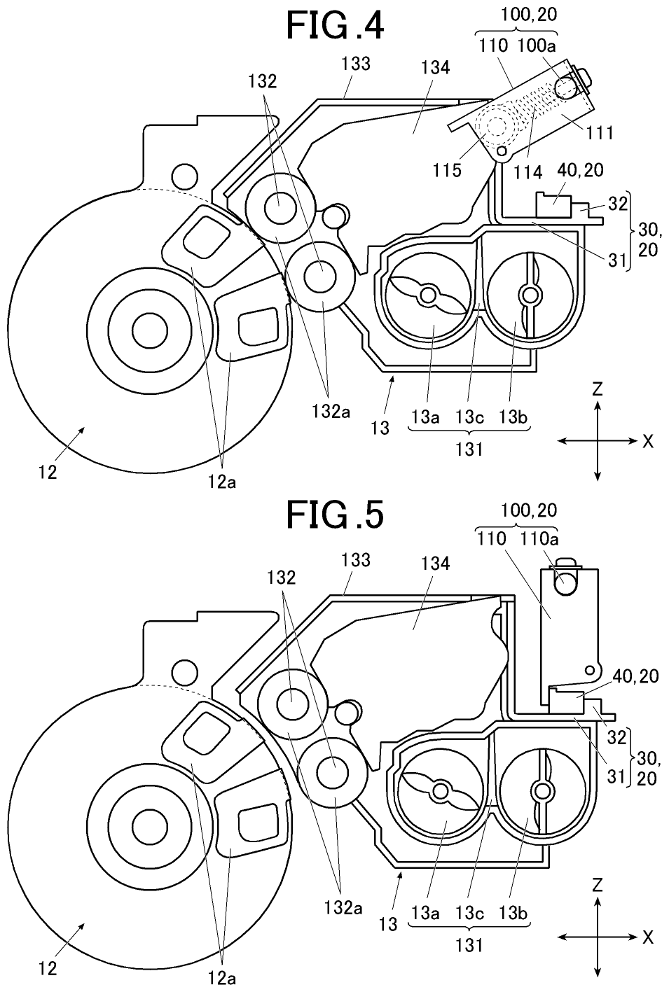

The image forming apparatus 1 includes a movement mechanism 20 that moves the developing device 13 at the time of replacement from a development position (shown in FIG. 4) where the developing rollers 132 face the photoconductor 12 and perform development to a separate position (shown in FIG. 5) where the developing rollers 132 are separate from the photoconductor 12 by a predetermined distance (gap).

As shown in FIG. 2, the movement mechanism 20 includes a movement unit 100 that applies force for moving the developing device 13, a first guide 30 that is disposed on the developing device 13 and extends in the axial direction (Y direction) of the photoconductor 12, and a second guide 40 that is disposed on the main body of the image forming apparatus 1, extends in the abovementioned axial direction, and is movable on the first guide 30 in the right-left direction (X direction).

The movement unit 100 includes: a shaft 100a that is disposed along the extending direction (Y direction) of the developing device 13; and the rotators 110 that rotate around the shaft 100a.

The rotators 110 are disposed at positions corresponding to the respective ends of the developing device 13 in the Y direction in the image forming apparatus 1, and simultaneously perform the same operation in the same direction.

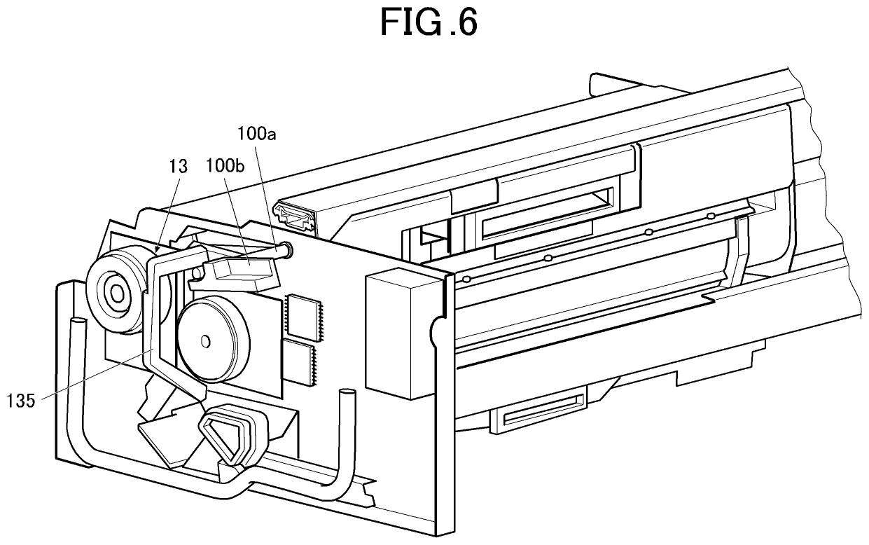

The shaft 100a is connected to a lever 100b (shown in FIG. 6) that is for a user to perform a rotating operation, and when the user operates the lever 100b), the shaft 100a rotates, and the rotators 110 rotate accordingly.

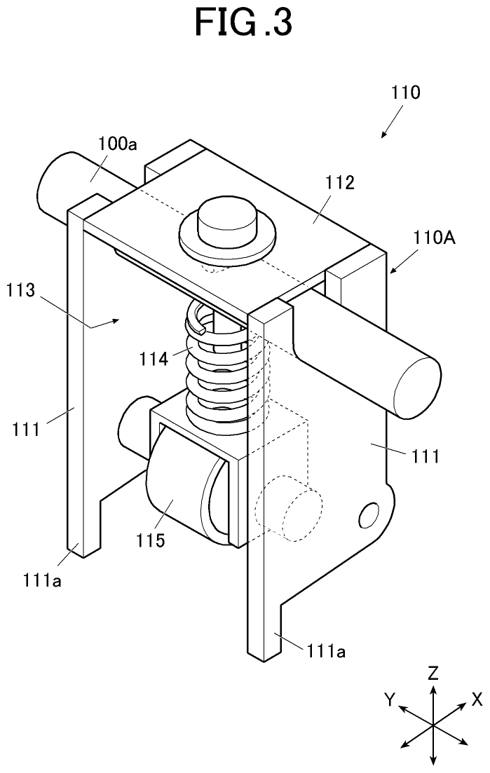

FIG. 3 is a schematic view showing configuration of the rotator(s) 110.

As shown in FIG. 3, the rotator 110 includes a frame 110A that is U-shaped as a whole. The frame 110A includes two plates 111, 111 that are substantially parallel and one connector 112 that connects ends on one side of these plates 111, 111, thereby forming a housing space 113.

The shaft 100a is inserted into the two plates 111, 111. In the housing space 113, a caster 115 is disposed. The caster 115 is attached to the shaft 100a via a spring 114. The two plates 111, 111 are partly cut off, thereby forming projections 111a on the open-end side of the frame 110A.

Returning to FIG. 2, the first guide 30 is disposed on the outer surface of the recess 133a of the housing 133 of the developing device 13 and extends along the depth direction (Y direction) of the housing 133.

More specifically, the first guide 30 includes: a horizontal part 31 disposed on the bottom surface of the recess 133a; and a projection 32 disposed, of the horizontal part 31, at the right end, which is far from the photoconductor 12. The projection 32 projects upward.

The first guide 30 has a length that covers the housing 133 in the lengthwise direction (Y direction).

The second guide 40 is a component connected to the main body of the image forming apparatus 1.

The second guide 40 is disposed on the first guide 30, extends along the depth direction (Y direction) of the housing 133, and is slidable on the horizontal part 31 in the right-left direction (X direction).

The second guide 40 also has a length that covers the housing 133 in the lengthwise direction (Y direction).

FIG. 4 shows the developing device 13 at the development position.

In the state in which the developing device 13 is fixed at the development position, each plate 134 is inserted between two plates 111, 111 of its corresponding rotator 110, and the caster 115 applies pressing force to the right end of the plate 134. Consequently, the left end of the plate 134 contacts the bearings 132a of the developing rollers 132, 132 by pressure.

Consequently, the bearings 132a contact restrictors 12a of the photoconductor 12 by pressure. At the development position, the photoconductor 12 and the developing rollers 132, 132 are accurately positioned and fixed, and hence the gap between the photoconductor 12 and the developing rollers 132, 132 can be ensured with high accuracy.

FIG. 5 shows the developing device 13 at the separate position.

To move the developing device 13 to the separate position, the user operates the lever 100b (shown in FIG. 6) counterclockwise, and the rotators 110 rotate counterclockwise accordingly from the state shown in FIG. 4, so that the projections 111a of the plates 111, 111 apply pressing force to the left end of the second guide 40.

Consequently, the second guide 40 slides rightward on the horizontal part 31 of the first guide 30 and applies pressing force to the left end of the projection 32.

Because the first guide 30 is a component disposed on the developing device 13, the developing device 13 itself moves rightward and separates from the photoconductor 12.

After the developing device 13 is moved in this manner to the separate position, this developing device 13 can be removed (and inserted).

When the user operates and rotates the lever 100b clockwise, the rotators 110 rotate clockwise accordingly from the state shown in FIG. 5, whereby the developing device 13 is moved from the separate position to the development position and fixed at the development position as described above. The first guide 30 moves leftward as the developing device 13 moves leftward, so that the projection 32 of the first guide 30 applies pressing force to the right end of the second guide 40 and moves the second guide 40 leftward. Hence, the second guide 40 does not interfere with the movement of the developing device 13.

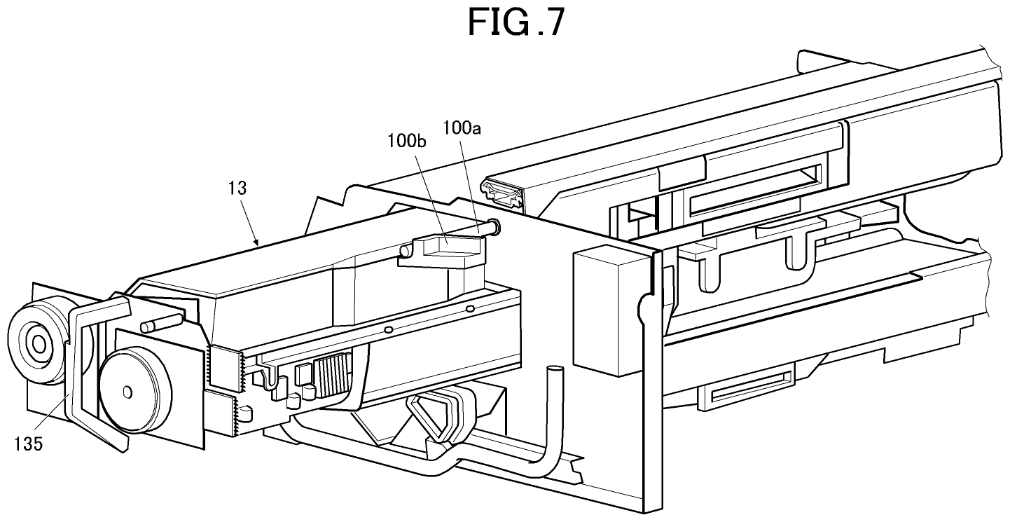

FIG. 6 shows the developing device 13 before pulled out, whereas FIG. 7 shows the developing device 13 after pulled out.

As shown in FIG. 6 and FIG. 7, a handle 135 is disposed on the front surface of the developing device 13. The user grasps the handle 135 and pulls the developing device 13 toward the front side of the image forming apparatus 1, thereby pulling out the developing device 13.

At the time, the first guide 30 moves in the Y direction along the second guide 40 and is restricted by the second guide 40. Hence, the developing device 13 is prevented from contacting and scratching the photoconductor 12. As in this embodiment, disposing the first guide 30 and the second guide 40 that each cover the photoconductor 12 in the Y direction further enhances this effect.

Thereafter, a new developing device 13 is inserted into the main body of the image forming apparatus 1. At this time too, the first guide 30 is restricted by the second guide 40. Hence, the same effect as the above can be obtained.

In the developing device 13, while the developing rollers 132, 132 holding the developer is carrying the toner to the photoconductor 12, the toner may be scattered by the rotation of the developing rollers 132, 132.

The scattered toner adheres to the housing 133 of the developing device 13 facing the developing rollers 132, 132. When the adhered toner accumulates, the toner (toner particles) agglomerates and falls off the housing 133. If the fallen toner adheres to the developing rollers 132, 132 or the photoconductor 12 in the middle of image forming, image failure (defective images) due to the toner is (are) likely to occur (be generated).

Hence, the image forming apparatus 1 according to this embodiment includes, for each developing device 13, a vibration mechanism 50 that vibrates the housing 133 of the developing device 13 to prevent the toner from adhering or agglomerating.

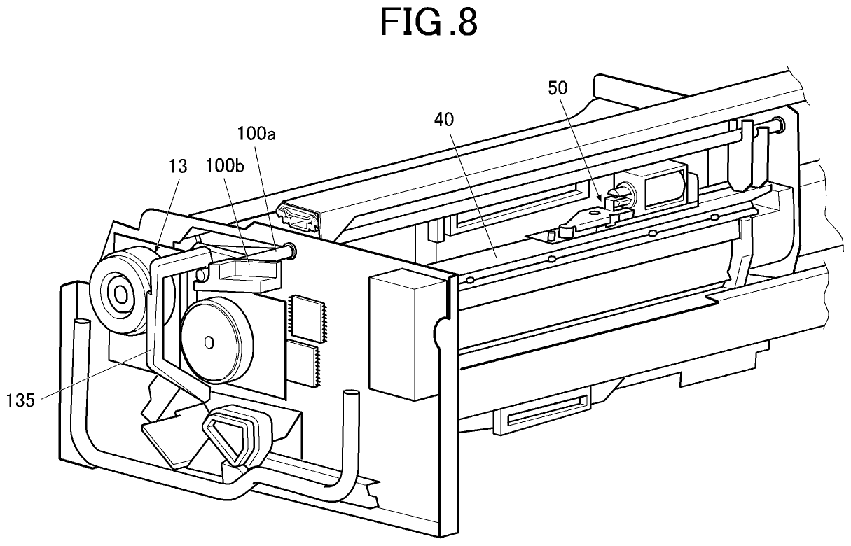

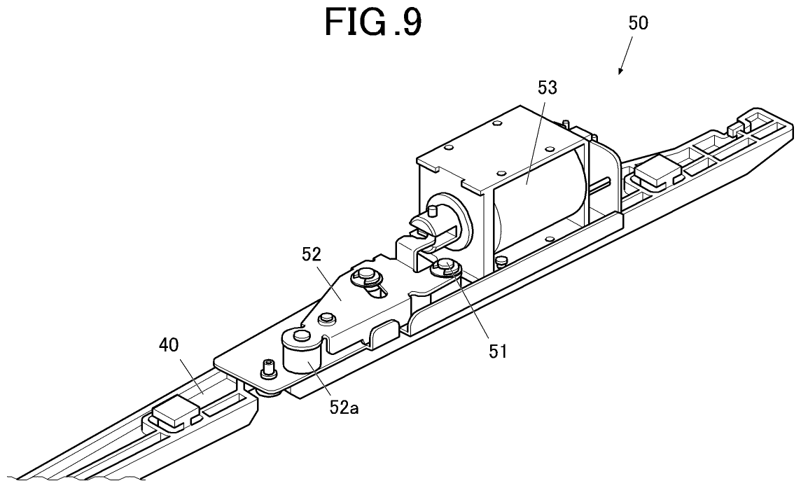

FIG. 8 and FIG. 9 are illustrations for explaining the vibration mechanism 50.

As shown in FIG. 8, the vibration mechanism 50 is disposed on the second guide 40.

That is, the vibration mechanism 50 is disposed on the main body side of the image forming apparatus 1 as a separate component from the developing device 13. Hence, pulling out the developing device 13 does not affect the vibration mechanism 50.

As shown in FIG. 9, the vibration mechanism 50 includes: a swing part 52 that swings around a fulcrum 51; and a driver 53 that applies driving force to the swing part 52 under the control of the controller 70.

The swing part 52 is a plate having the base end pivotally supported by the fulcrum 51 and the tip end provided with a weight 52a. As the driver 53, an electromagnetic solenoid may be used, for example.

The swing part 52 swings around the fulcrum 51 in the direction along the moving direction (X direction) of the developing device 13, thereby hitting the housing 133 of the developing device 13 and applying impacts thereto.

Because the vibration mechanism 50 is disposed on the second guide 40, as the second guide 40, namely the developing device 13, moves in the X direction, the vibration mechanism 50 moves in the X direction. Hence, the vibration mechanism 50 can be always disposed in the vicinity of the developing device 13, so that the effect of the vibration can be kept.

In the case of components that utilize force in the direction of rotation, such as the vibration mechanism 50 of this embodiment, large strokes of swing parts (in this embodiment, the swing part 52) cause losses of vibration energy.

The vibration mechanism 50 disposed in the vicinity of the developing device 13 can hit the housing 133 of the developing device 13 in the closest possible direction (direction as similar as possible) to the orthogonal direction (X direction), thereby reducing the losses of the vibration energy.

Further, the tip end of the swing part 52 provided with the weight 52a allows centrifugal force to act, thereby efficiently dropping the toner adhering to the housing 133.

### [Effects of Embodiments]

As described above, according to this embodiment(s), the image forming apparatus 1 includes: at least one photoconductor 12; and for each photoconductor 12, the developing device 13 that supplies a developer to the photoconductor 12, wherein the developing device 13 is attachable to and detachable from the main body of the image forming apparatus 1, and the main body includes, for each developing device 13, the vibration mechanism 50 that vibrates the developing device 13.

Hence, it is unnecessary to discard the vibration mechanism 50 at the time of replacing the developing device 13, thereby curbing unnecessary production of wastes and increase in running cost.

Further, according to this embodiment, the image forming apparatus 1 further includes, for each developing device 13, the movement mechanism 20 that moves the developing device 13 between the development position where the developing device 13 faces the photoconductor 12 and performs development and the separate position where the developing device 13 is separate from the photoconductor 12 by a predetermined distance, wherein the vibration mechanism 50 is configured to move with the movement of the developing device 13 by the movement mechanism 20.

More specifically, the movement mechanism 20 includes: the first guide 30 that is disposed on the developing device 13 and extends in the Y direction; the second guide 40 that is disposed on the main body, extends in the Y direction, and is movable on the first guide 30 in the X direction; the rotator(s) 110 that applies pressing force to the second guide 40, thereby moving the second guide 40 on the first guide 30 in the X direction to move the developing device 13 to the separate position, wherein the vibration mechanism 50 is disposed on the second guide 40.

Hence, the vibration mechanism 50 can be always disposed in the vicinity of the developing device 13, so that the effect of the vibration can be always kept.

Further, according to this embodiment, when the developing device 13 is at the separate position, the developing device 13 is insertable into and removable from the main body in the state in which the first guide 30 is restricted by the second guide 40.

Hence, the photoconductor 12 can be prevented from being scratched at the time when the developing device 13 is inserted into the main body and at the time when the developing device 13 is removed from the main body.

Further, according to this embodiment, the first guide 30 and the second guide 40 each cover the photoconductor 12 in the axial direction.

Hence, the photoconductor 12 can be more certainly prevented from being scratched at the time when the developing device 13 is inserted into the main body and at the time when the developing device 13 is removed from the main body.

Further, according to this embodiment, the vibration mechanism 50 includes the swing part 52 that swings around the fulcrum 51, and the swing part 52 swings, thereby applying an impact(s) to and vibrating the housing 133 of the developing device 13. Further, the swing part 52 swings in the direction along the moving direction of the developing device 13.

Hence, the developing device 13 can be efficiently vibrated.

Further, according to this embodiment, the rotator 110 applies pressing force to the developing device 13, thereby moving the developing device 13 to the development position and fixing the developing device 13 at the development position.

Thus, the rotator(s) 110 doubles as a mechanism that moves the developing device 13 to the development position where the developing device 13 abuts (contacts) the photoconductor 12 and a mechanism that fixes (presses) the developing device 13.

The specific details described in the above embodiment(s), such as the components, the configurations and the control contents and order, can be appropriately modified without departing from the scope of the present disclosure.

For example, instead of the rotators 110 of the above embodiment, other component(s) may be employed as long as they can apply the pressing force to the developing device 13 and the second guide 40.

Further, although the pressing force is applied to the bearings 132a of the developing rollers 132, the pressing force may be applied to component(s) other than the bearings 132a.

Still further, the number of developing rollers 132 is not limited to the number thereof in the above embodiment.

Yet further, the configuration of the vibration mechanism 50 in the above embodiment is merely an example, and hence may be any configuration as long as the vibration mechanism 50 can be set on/in the main body.

Although some embodiments of the present invention have been described and illustrated in detail, the disclosed embodiments are made for purposes of not limitation but illustration and example only. The scope of the present invention should be interpreted by terms of the appended claims

What is claimed is:

1. An image forming apparatus comprising:
a photoconductor; and
a developing device that supplies a developer to the photoconductor,
wherein the developing device is attachable to and detachable from a main body of the image forming apparatus, and
wherein the main body includes a vibration mechanism that vibrates the developing device.

2. The image forming apparatus according to claim 1, further comprising a movement mechanism that moves the developing device between a development position where the developing device faces the photoconductor and performs development and a separate position where the developing device is separate from the photoconductor by a predetermined distance,
wherein the vibration mechanism is configured to move with the movement of the developing device by the movement mechanism.

3. The image forming apparatus according to claim 2,
wherein the movement mechanism includes:
a first guide that is disposed on the developing device and extends in an axial direction of the photoconductor;
a second guide that is disposed on the main body, extends in the axial direction, and is movable on the first guide in an orthogonal direction orthogonal to the axial direction; and
a pressing part that applies a pressing force to the second guide, thereby moving the second guide on the first guide in the orthogonal direction to move the developing device to the separate position,
wherein the vibration mechanism is disposed on the second guide.

4. The image forming apparatus according to claim 3, wherein when the developing device is at the separate position, the developing device is insertable into and removable from the main body in a state in which the first guide is restricted by the second guide.

5. The image forming apparatus according to claim 3, wherein the first guide and the second guide each cover the photoconductor in the axial direction.

6. The image forming apparatus according to claim 1,
wherein the vibration mechanism includes a swing part that swings around a fulcrum, and
wherein the swing part swings, thereby applying an impact to and vibrating a housing of the developing device.

7. The image forming apparatus according to claim 6, wherein the swing part swings in a direction along a moving direction of the developing device.

8. The image forming apparatus according to claim 3, wherein the pressing part applies a pressing force to the developing device, thereby moving the developing device to the development position and fixing the developing device at the development position.
